(19) United States
(12) Patent Application Publication
(10) Pub. No.: US 2024/0010570 A1
(43) Pub. Date: Jan. 11, 2024

(54) MANUFACTURE OF A CERAMIC COMPONENT

(71) Applicant: ROLEX SA, Geneva (CH)

(72) Inventors: Carine Bienvenu, Pringy (FR); Pierre Huguet, Allinges (FR); Cécile Pigny, Cranves-Sales (FR); Ollivier Pujol, Lausanne (CH)

(73) Assignee: ROLEX SA, Geneva (CH)

(21) Appl. No.: 18/252,329

(22) PCT Filed: Nov. 12, 2021
(86) PCT No.: PCT/EP2021/081598

§ 371 Date: May 9, 2023

(30) Foreign Application Priority Data
Nov. 12, 2020 (EP) 20207183.3

(51) Int. Cl. C04B 35/488; C04B 35/638; C04B 35/64; C04B 41/45; C04B 41/50; C04B 41/00; C04B 41/87; A44C 27/00

(52) U.S. Cl. CPC C04B 35/4885; C04B 35/638; C04B 35/64; C04B 41/458; C04B 41/4535; C04B 41/5036; C04B 41/0072; C04B 41/87; A44C 27/001; C04B 2235/3246; C04B 2235/3225; C04B 2235/3217; C04B 2235/3206; C04B 2235/3272; C04B 2235/3279; C04B 2235/3241; C04B 2235/785; C04B 2235/77; C04B 2235/616

(57) ABSTRACT

Sintered technical ceramic based on zirconia ZrO2, characterised in that it comprises: —less than or equal to 3.6 wt % and greater than or equal to 2.5 wt % of yttrium oxide Y2O3; —at least one complementary component from hafnium oxide HfO2, alumina Al2O3, and magnesium oxide MgO; —at least one additional element from Fe, Ni, Cr, Zn, Co, Mn, Cu, Ti, Ta, W, Pt, the weight proportion of said at least one additional element being greater than or equal to 0.1 wt %, or greater than or equal to 0.5 wt %, or greater than or equal to 1 wt %, or greater than or equal to 1.5 wt %.

### INTRODUCTION

The present invention relates to a sintered technical ceramic based on zirconia ZrO₂, to a body or to a timepiece component comprising such a sintered technical ceramic. It also relates to a timepiece comprising such a sintered technical ceramic or such a body or such a timepiece component. Lastly, it relates to a process for manufacturing a sintered technical ceramic based on zirconia ZrO₂.

### PRIOR ART

In the field of horology, just as in jewelry, it is known to use components made of technical ceramic, which will also be referred to more simply as ceramic. The adjective “technical” refers to the high-performance properties of the selected ceramics. Specifically, these technical ceramics can achieve very high mechanical, thermal, or even electrical, and/or biochemical properties which render them suitable for use for forming timepiece components, notably timepiece movement components, but also watch exterior components. The technical ceramics used in this case are distinguished from traditional ceramics by their composition, since they originate from purified synthetic powders and not from natural mineral powders such as feldspar or kaolin.

The process for manufacturing a ceramic component comprises a first phase consisting in preparing the raw material, that is to say a ceramic powder, such as a ceramic powder based on zirconia and/or alumina.

A second phase of the process for manufacturing a ceramic component consists in incorporating a binder into the ceramic powder obtained in the first phase. Such a binder generally consists of one or more organic compounds. The nature and proportion of the binder depend on the intended process in a third phase, and at the end of this second phase reference is generally made to a binded ceramic powder.

The third phase consists in shaping the ceramic component. To that end, a first approach comprises a step of pressing a cluster of binded particles obtained at the end of the second phase: in such a process, the second phase prepares a binded ceramic powder in the form of atomized granules for pressing. A second approach consists in shaping by injection into a mold. In such a case, the preparation resulting from the second phase is a binded ceramic powder referred to as “feedstock”. A third, more traditional, approach consists in shaping by casting into a mold, commonly referred to as slip casting, followed by drying. In such a case, the preparation resulting from the second phase is a binded ceramic powder in suspension, referred to as slip or also “slurry”. At the end of the third phase, the ceramic component, often also referred to as green body, has a shape which is close to its final shape and contains both the ceramic powder and the binder. Other shaping techniques such as gel casting, freeze casting or coagulation casting techniques may be used.

A fourth phase allows the ceramic component to be finished.
This fourth phase comprises a first debinding step which is applied to the green body, and which can be carried out in a number of ways:
   either by a thermal treatment, which is referred to as “pre-sintering”.
   or by a treatment using a solution, which may for example be aqueous.
This step gives rise to the extraction of at least a portion of the binders: it is therefore a debinding or a partial debinding. For simplification of the notations, this step is thus referred to as “debinding”. The resultant component is a green body that is at least partially debinded: if it is totally debinded, it is referred to as brown body, otherwise it retains the designation of still-green body or green body.
A second step allows the component to be compacted, eliminating the pores left by removal of the binder. This second step generally consists in a thermal sintering treatment (firing at high temperature). The final mechanical properties of the component appear only at the end of this fourth phase and are the result of the reactions between the various constituents of the component but also the gases present in the furnace, which come into play during the thermal treatment, and the pressure. These reactions are complex and sometimes unpredictable.

From among the technical ceramics, ceramics based on zirconia are commonly used because they have high mechanical properties. It is desirable to improve these mechanical properties. However, it appears that the solutions of the prior art seeking to improve the mechanical properties of such a ceramic increase the failure stress to the detriment of the fracture toughness, which is reduced, or vice versa.

On the other hand, it may be necessary to add pigments to the ceramic component, which is inherently a white body.

Document U.S. Pat. No. 10,202,307 describes the manufacture of a zirconia-based component. That document discloses a process which requires the obligatory implementation of a step of hot isostatic pressing, also known by its acronym HIP, in order to optimize the mechanical properties of the resultant component, notably its failure stress and its fracture toughness. Such a step is very constraining because its implementation is costly and complex.

Thus, a first object of the present invention is to propose a solution for a technical ceramic based on zirconia which makes it possible to achieve a high performance, notably high mechanical properties with regard to its failure stress and its fracture toughness.

A second object of the present invention is to propose a solution for a technical ceramic based on zirconia which can be manufactured in a simple manner.

A third object of the present invention is to propose a solution for a technical ceramic based on zirconia which makes it possible to achieve an attractive esthetic appearance.

### BRIEF DESCRIPTION OF THE INVENTION

To that end, the invention concerns a sintered technical ceramic based on zirconia ZrO₂, wherein it comprises or consists of:
yttrium oxide Y₂O₃ in a proportion by mass of less than or equal to 3.6% and greater than or equal to 2.5%;
at least one complementary component from among hafnium oxide HfO₂, alumina Al₂O₃ in a proportion by mass of between 0.1% and 0.5%, and magnesium oxide MgO;
at least one additional element from among Fe, Ni, Cr, Zn, Co, Mn, Cu, Ti, Ta, W, Pt, the proportion by mass of this at least one additional element being greater than or equal to 0.1%, or even greater than or equal to 0.3%, or even greater than or equal to 0.5%, or even greater than or equal to 1%, or even greater than or equal to 1.5%.

The invention is defined more specifically by the claims.

### BRIEF DESCRIPTION OF THE FIGURES

These objects, features and advantages of the present invention will be set out in detail in the following description of particular embodiments, given by way of non-limiting example with reference to the appended figures, in which:

FIG. 1 shows a flow chart of the steps of the process for manufacturing a component made of colored technical ceramic for a timepiece, according to one embodiment of the present invention.

FIG. 2 shows a table detailing the composition of an impregnation solution for manufacturing a technical ceramic according to a first example embodiment of the invention.

FIG. 3 shows a table detailing the compositions of a plurality of compared ceramics in order to illustrate the technical effect of the invention.

FIG. 4 shows a table detailing the properties of said plurality of compared ceramics in order to illustrate the technical effect of the invention.

FIG. 5 illustrates, in particular, a timepiece component comprising a technical ceramic according to the invention.

In the following, a ceramic body or component is defined as an element made of a material comprising principally at least one dense ceramic. “Dense” ceramic is understood to mean a ceramic whose density is between 95% and 100% of the theoretical density of the material in question. In this document, the terms “ceramic” or “technical ceramic” denote dense materials based on stabilized zirconium oxide.

In addition, “based on zirconia” is understood to mean a material which in all cases comprises mostly a zirconia component, in a proportion by weight of at least 50%, or even of at least 75%, or even of at least 90%. For example, the ceramic material according to the invention comprises at least 50% by weight of zirconia.

In all cases, the ceramic does not contain any organic compounds. Thus, the generic term “binded ceramic” denotes a composite material consisting of the ceramic and a binder which generally consists of one or more organic compounds, in variable proportions. The term “green body” denotes a shaped and binded ceramic, and the more precise term “still-green body” denotes a shaped and partially debinded ceramic. “Brown body” denotes a shaped and totally debinded ceramic. All three of the terms “green body”, “still-green body” and “brown body” thus denote a body in an intermediate state during the process for manufacturing a ceramic body, notably prior to a sintering step.

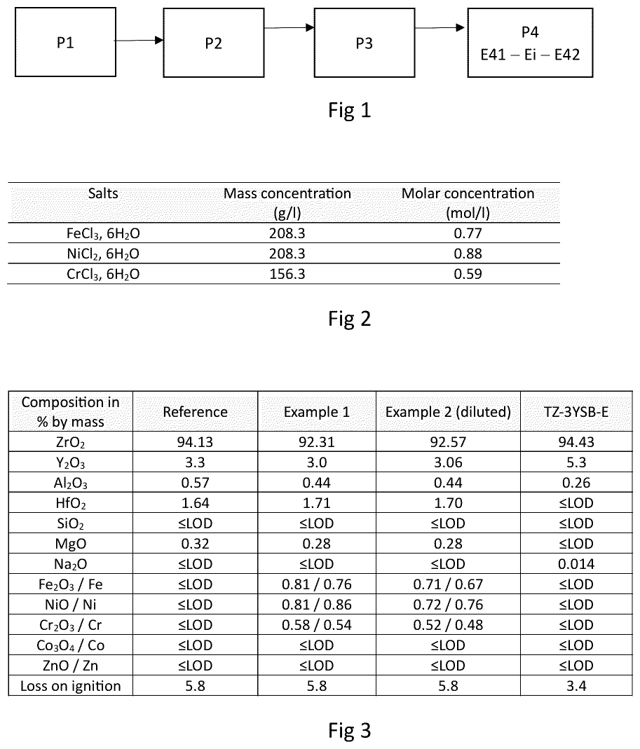

The process for manufacturing a ceramic body according to an embodiment of the invention comprises the phases and steps schematically shown by the flow chart in FIG. 1.

This manufacturing process comprises the usual phases P1 to P4 of the process, that is to say the preparation of the ceramic powder (P1), the addition of a binder (P2), the shaping of the component (P3) and the thermal treatments of debinding and sintering (P4). According to the invention, this last phase will be modified, as will be described in detail below. The traditional steps of these phases will not be described in detail since they are known from the prior art. A person skilled in the art will therefore be able to implement them, including according to any existing variants or equivalences.

According to one advantageous embodiment, the two first phases will be carried out so as to obtain a conventional zirconia powder, for example a marketed zirconia denoted by the term binded 2Y zirconia. The third phase of shaping is likewise carried out by any known technique, such as casting, uniaxial pressing, a low-pressure or high-pressure injection process, in order to obtain a green body.

The first phase P1 may comprise a step of manufacturing the zirconia powder comprising yttrium oxide Y₂O₃ for example by emulsion detonation synthesis (EDS), as described in document EP2630079. Yttrium oxide Y₂O₃ is preferably in a proportion by mass of less than or equal to 3.7% and greater than or equal to 2.6%.

In addition, the zirconia powder comprises at least one complementary component from among hafnium oxide HfO₂, alumina Al₂O₃, and magnesium oxide MgO, the function of which will be described in detail below.

The fourth phase P4 is divided into a plurality of steps, including the two steps of debinding E41 and sintering E42, in a conventional manner, as mentioned above. The debinding step E41 is a partial or total debinding, resulting in a still-green body or a brown body, respectively. According to the invention, a step of impregnation Ei of the ceramic is additionally implemented during this fourth phase, after the first, debinding step E41.

In summary, in all cases, the fourth phase P4 of the process therefore comprises the steps detailed below:
a first, debinding step E41, which consists in at least partially debinding the previously obtained green body, by any known technique, for example a specific thermal treatment, in order to obtain a still-green or brown body;
an intermediate impregnation step Ei, which is implemented after this first step. This step may therefore be implemented after a first, total debinding step E41, thus on a brown body, or in a variant after a partial debinding step E41, thus on a still-green body. As a result, the second, sintering step E42 may be implemented respectively on an impregnated brown body or on an impregnated still-green body;
a second, sintering step E42, which consists in sintering the still-green or brown body resulting from the preceding step (E41+Ei). Advantageously, this sintering step implements conventional sintering in air at atmospheric pressure (also referred to as natural sintering). It would also be conceivable to perform sintering under a controlled atmosphere, that is to say with gases whose nature and partial pressure are imposed and different from air (dinitrogen N₂ and/or argon Ar and/or dihydrogen H₂ and mixtures thereof in variable proportions, in particular forming gas, corresponding to a mixture of N₂ and H₂, for example with 95% N₂ and 5% H₂). In this step, the impregnated still-green or brown body may have been dried beforehand prior to the sintering. Advantageously, this second, sintering step is carried out at a temperature greater than 1300° C., notably of the order of 1350° C.

According to the invention, the step of impregnation Ei of the brown or still-green body is carried out so as to add thereto at least one additional element from among the elements Fe, Cr, Ni. In an alternative, the step of impregnation Ei of the brown or still-green body is carried out so as to add thereto at least one additional element from among the elements Fe, Cr, Ni, Co, Cu, Mn; or even from among Fe, Cr, Ni, Co, Cu, Mn, Zn, Ti, Ta, W; or even from among Fe, Cr, Ni, Co, Cu, Mn, Zn, Ti, Ta, W, Pt. Thus, a single additional element may be added, or in a variant any combination of a plurality of these additional elements may be added.

In addition, according to the embodiment, the proportion by mass (measured in relation to the finished sintered ceramic) of this at least one additional element is greater than or equal to 0.1%. In a variant, it could be greater than or equal to 0.2%, or greater than or equal to 0.3%, or greater than or equal to 0.4%, or greater than or equal to 0.5%, or greater than or equal to 1%, or greater than or equal to 1.5%. In addition, this proportion by mass is advantageously less than or equal to 20%, or even less than or equal to 15%. These limits for the proportion by mass apply to each additional element. This impregnation step is carried out according to the method described in documents EP2746242 and/or WO2014096318 and will not be described in detail again. Notably, this impregnation step may comprise the use of an aqueous solution in which the additional element is present, for example in the form of a metal salt. It has surprisingly been found that this impregnation step, which was developed according to those documents in order to perform a function of coloring a ceramic, makes it possible to improve the mechanical performance properties of a ceramic based on zirconia, under the conditions of the invention.

Finally, the process may comprise a last, optional termination step, for example a rectification and/or polishing step.

Thus, the invention makes it possible to manufacture a sintered technical ceramic based on zirconia, exhibiting improved mechanical properties, in a simple and easily reproducible manner. Specifically, it appears that a body made of sintered technical ceramic according to the invention has a fracture toughness greater than or equal to 10 MPa·m^{0.5}, or even greater than or equal to 11 MPa·m^{0.5}, and has a failure stress greater than or equal to 1400 MPa, or even greater than or equal to 1650 MPa, or even greater than or equal to 1800 MPa. It is noted that the process makes it possible to not use the constraining HIP (hot isostatic pressing) step.

At the same time, the invention makes it possible to perform the second function of coloring a ceramic based on zirconia in black, with an opaque appearance, or even in other colors, this having the second advantage of providing it with a particularly attractive appearance that is greatly sought after in the fields of horology and jewelry. Thus, the presence of one or more of the selected additional elements, in the ceramic based on zirconia as described above, not only makes it possible to obtain a technical ceramic exhibiting improved performance properties but also to color it in black, in green, in brown, in blue, or even in other colors to provide it with a particularly attractive appearance. It is noted that these additional elements are present in the ceramic in any form, notably in an oxidized form.

The invention also relates to the material itself obtained by the process according to the invention, that is to say a sintered technical ceramic based on zirconia ZrO₂, which comprises:
yttrium oxide Y₂O₃ in a proportion by mass of less than or equal to 3.6% and greater than or equal to 2.5%;
at least one complementary component from among hafnium oxide HfO₂, alumina Al₂O₃, and magnesium oxide MgO;
one or more additional elements from among Fe, Ni, Cr, Zn, Co, Mn, Cu, Ti, Ta, W, Pt, notably in oxidized form, the proportion by mass of each additional element being greater than or equal to 0.1%, or even greater than or equal to 0.2%, or even greater than or equal to 0.3%, or even greater than or equal to 0.4%, or even greater than or equal to 0.5%, or even greater than or equal to 1%, or even greater than or equal to 1.5%.

In a variant, yttrium oxide Y₂O₃ is present in a proportion by mass of less than or equal to 3.5%, or even less than or equal to 3.4%, or even less than or equal to 3.3%, or even less than or equal to 3.2%, or less than or equal to 3.1%.

According to one embodiment, the sintered technical ceramic comprises a proportion by mass of zirconia ZrO₂ of greater than or equal to 80%, or even greater than or equal to 90%.

According to one embodiment, the sintered technical ceramic comprises a proportion by mass of zirconia ZrO₂ of less than or equal to 94%, or even less than or equal to 93%.

In addition, according to an advantageous embodiment, the sintered technical ceramic comprises hafnium oxide HfO₂ in a proportion by mass comprised within the range]0%; 3%], or even]0%; 2%], or even comprised between 1.6% and 1.9%; more generally, hafnium oxide HfO₂ could be used for any non-zero proportion by mass, in particular preferably any proportion by mass greater than or equal to 1.3%, or even greater than or equal to 1.5%, or even greater than or equal to 1.6%, and/or less than or equal to 1.9%, or even less than or equal to 2%, or even less than or equal to 3%; and/or
alumina Al₂O₃ in a proportion by mass comprised between 0.1% and 0.5% or between 0.1% and 0.45%; and/or
magnesium oxide MgO in a proportion by mass comprised within the range]0%; 0.4%], or even comprised between 0.05% and 0.4% or between 0.05% and 0.3% inclusive.

The technical function of the alumina is to reduce the aging kinetics of the zirconia, and it makes it possible to promote the retention of good mechanical properties over time. According to a particular embodiment, the sintered technical ceramic comprises alumina Al₂O₃ in a proportion by mass comprised between 0.1% and 0.5%, and possibly hafnium oxide HfO₂ and/or magnesium oxide MgO.

According to one embodiment, the total proportion by mass of the elements Zr+Hf+Y+Al+Si+Mg+Fe+Ni+Cr+Zn+Co+Mn+Cu+Ti+Ta+W+Pt+O in the sintered technical ceramic is greater than or equal to 99.9%. In other words, the total proportion by mass of the elements taken from among Zr, Hf, Y, Al, Si, Mg, Fe, Ni, Cr, Zn, Co, Mn, Cu, Ti, Ta, W, Pt and O in the technical ceramic is greater than or equal to 99.9%.

In other words, the technical ceramic consists of zirconia ZrO₂, yttrium oxide Y₂O₃, at least one complementary component from among hafnium oxide HfO₂, alumina Al₂O₃, and magnesium oxide MgO, and one or more additional elements from among Fe, Ni, Cr, Zn, Co, Mn, Cu, Ti, Ta, W, Pt. Such an additional element may be present in the sintered ceramic in an oxidized form of this additional element, for example in the form of a complex oxide of a plurality of elements that may additionally originate from constituents of the material, or a spinel. In an alternative, such an additional element may also be present in the form of a carbide, a nitride or a boride. The ceramic may additionally comprise any other element in the form of non-detectable, thus negligible, traces.

According to one embodiment, the sintered technical ceramic according to the invention comprises grains of zirconia, the mean equivalent diameter of which is greater than or equal to 200 nm, or even greater than or equal to 250 nm, and grains containing at least one additional element, the equivalent diameter of which is greater than or equal to 200 nm, or even greater than or equal to 250 nm. In addition, the mean equivalent diameter of the grains of zirconia and/or of the grains containing at least one additional element may be less than or equal to 2 μm. In addition, the mean equivalent diameter of the grains of zirconia may be less than or equal to 500 nm, or even less than or equal to 400 nm. Thus, advantageously, the dimension of the grains of zirconia is between 200 nm and 500 nm or 400 nm. Below a dimension of 200 nm, the ceramic would have a more stable tetragonal phase which would be less favorable to the fracture toughness and the failure stress which would be less optimal and lower. Above a dimension of 400 nm or 500 nm, the ceramic would have a more unstable tetragonal phase, and this would be less favorable because its aging would be more rapid.

The invention thus makes it possible to form a body made of sintered technical ceramic having a density greater than or equal to 6.0 g/cm³.

The invention of course also relates to a timepiece component comprising such a sintered technical ceramic. Such a timepiece component may be a component of the movement, such as a timepiece staff, in particular a balance staff.

Such a staff has to:
have a high elastic limit so as to not deform plastically in the event of significant shocks,
be tough so as to not break in the event of significant shocks, and
be hard, principally at the pivots, so as to not wear or become marked in the event of everyday shocks, and notably in order to optimize the quality factor and the isochronism of the timepiece that it equips in the case of a balance staff, the staff being constantly in motion.

Thus, the solution for a technical ceramic according to the invention advantageously makes it possible to meet the requirements mentioned above.

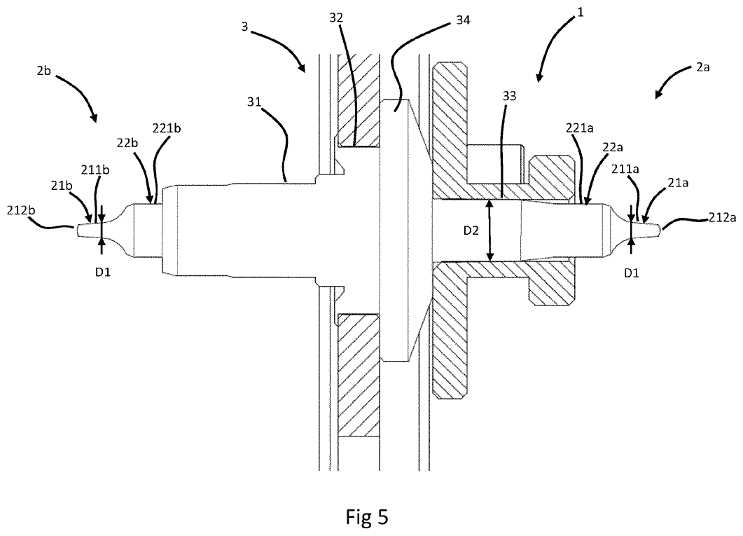

An example of a staff is illustrated in FIG. 5. Preferably, such a staff 1 comprises at least one first functional portion 2a; 2b (two portions in the illustrated example) including at least one part 221a; 221b of a pivot shank 22a; 22b and/or at least one part 211a; 211b of a pivot 21a; 21b.

A first outer diameter D1 of the at least one first functional portion is less than 0.5 mm, or even less than 0.4 mm, or even less than 0.2 mm, or even less than 0.1 mm.

Preferably, the at least one first functional portion has a surface of revolution, especially a cylindrical surface or a conical surface or a truncated conical surface or a surface with a curve generating surface.

Preferably, the at least one first functional portion has a convex end 212a; 212b.

Furthermore, the staff 1 may comprise a second functional portion 3, notably:
a second functional portion 31, 32, 33, 34 for receiving a timepiece component, notably a balance wheel, a plate, a balance spring collet, a toothed wheel, or
a second portion for pivoting of a timepiece component on the staff, or
a second meshing portion, notably a toothing.

Preferably, the second functional portion has a second outer diameter D2 less than 2 mm, or even less than 1 mm, or even less than 0.5 mm.

Still preferably, the ratio of the dimension of the first diameter to the dimension of the second diameter is less than 0.9, or even less than 0.8, or even less than 0.6, or even less than 0.5, or even less than 0.4.

In an alternative, such a timepiece component may also be a pawl, in particular a pawl for automatic winding, a pinion, a wheel or a stone.

It may also be a watch exterior component such as a bezel disk, a bezel, a winding crown, a watch case, a watch case back, a watch band link, or a watch band clasp, in particular a watch band clasp cover or a watch band clasp cover element.

The invention also relates to a timepiece, notably a wristwatch, comprising such a sintered technical ceramic or at least a body made of sintered technical ceramic or at least a timepiece component as described above.

Advantageously, the timepiece comprises a timepiece component comprising a sintered technical ceramic based on zirconia according to the invention. This component may be articulated, notably pivot-mounted, within the timepiece.

As an alternative, this component may be fastened within the timepiece by force-fitting, such as driving or clip fastening.

The technical effects obtained with a technical ceramic of the invention will now be illustrated below in the context of precise examples and measurements of mechanical properties and crystallographic structures.

The following mechanical properties will be considered below:
the measured hardness is the Vickers hardness and is evaluated with a Tukon™ 1202 Wilson Hardness microhardness tester or with a KB250 Prüftechnik hardness tester, under a load of 1 kg or 500 g according to the cases. The measurement is repeated ten times on a specimen;
the failure stress is determined by the ball-on-three-balls biaxial bending test (denoted B3B test) on each specimen. This test, which is applicable to brittle materials, is described in the article by A. Börger, P. Supancic, R. Danzer, “The ball on three ball test for strength testing of brittle discs: stress distribution in the disc”, Journal of the European Ceramic Society, vol. 22, pp. 1425-1436 (2002). The principle of the test consists in stressing a pellet between four balls using a tensile testing machine. The breaking force is then used in the calculation of the failure stress;
the fracture toughness is evaluated by what is referred to as direct indentation. An impression is produced with a Vickers indenter with a specific load according to the cases, for 15 seconds, using a KB250 Prüftechnik hardness tester. Nine measurements are carried out per pellet. The dimensions of the diagonals of the impressions and of the cracks at the corners of the impression are measured. The dominant shape of any generated cracks is the Palmqvist shape. From among the formulae for evaluating the K_{IC} that are suitable for this crack shape according to the literature [C. Ponton and R. Rawlings, “Vickers indentation fracture toughness test Part 1 Review of literature and formulation of standardised indentation toughness equations” The Institute of Metals, vol. 5, pp. 865-872 (1989)], use is made of the formula proposed by K. Niihara:

$${K}_{IC} = 0.0089 {( \frac{E}{HV} )}^{2 / 5} ( \frac{F}{a \cdot {l}^{0.5}} )$$

Where:
K_{IC}: fracture toughness [MPa·m^{0.5}]
E: Young's modulus [GPa]
HV: Vickers hardness [GPa]
F: force applied during the indentation [N]
a: half the diagonal length of the impression [m]
I: half the length of the cracks (the length of the impression is excluded) [m].

It is noted that these mechanical properties are measured at ambient temperature. Specifically, the ceramic is intended for a timepiece application, and the properties therefore relate to a timepiece component which will be intended for functionality at ambient temperature.

The crystallographic structure is observed using the approach below:
the crystalline phases are identified by X-ray diffraction measurements in Bragg-Brentano geometry. The phases are quantified by means of the Rietveld method. For the measurement, as for the quantification, the results are given for a depth corresponding to the depth of penetration of the X-rays, that is to say 10 to 20 μm depending on the angle of incidence of the X-rays. The results are given in mass concentration for each phase. The grain size is evaluated according to the intercept method, from international standard ISO 643.

The other evaluated properties are listed below:
the density is measured using a scale and evaluated by way of the Archimedean thrust principle, from a measurement of each part in air then in ethanol;
the color is measured by spectrophotometry. The measurements are carried out in reflection with a measurement aperture of 4 mm. Reflectance measurements are carried out between 360 nm and 740 nm with the observer at 10⁰ and the illuminant D65. The luminosity L* and the chromaticity values a* and b* are evaluated in the space defined by the International Commission on Illumination, CIE L*a*b*, as indicated in “Technical Report of Colorimetry” CIE 15: 2004. The measurements are carried out in SCI (Specular Component Included) mode and SCE (Specular Component Excluded) mode; they are presented in this document in SCI mode;
the chemical composition is measured by ICP-OES spectrometry (Inductively Coupled Plasma Optical Emission Spectrometry). It is evaluated by employing a mineralization method based on milling (in a zirconia mill) beforehand in order to obtain the powder, then microwave-assisted dissolution in a multi-acid mixture of the type HCl—HNO₃—HF. The aim is to measure out (in percentage by mass) all the elements. Since the milling method is a source of contamination, the introduced elements and their concentrations are evaluated on alumina single crystals, so as to be able to subtract their contribution. Likewise, the inputs of contamination by the reactants are taken into account.

Reference specimens are formed in the manner detailed below. A commercial ceramic powder of binded yttriated 2Y zirconia, sold by the commercial entity Innovnano-Materials Avancados SA under the reference “S18/25 lot 1701PA677”, is used. It is a powder characterized by the acronym RTP (Ready-To-Press), meaning that it has been atomized and that it comprises pressing binders. The ceramic powder itself has been obtained by the EDS method (Emulsion Detonation Synthesis). This zirconia ceramic powder contains an yttria content of 3.3% by mass. The zirconia constituting the reference specimen is manufactured with this powder, without additions (apart from the binders, which are eliminated during the manufacture of the sintered ceramic).

In certain variants, use may specifically be made of an yttriated 2Y zirconia powder containing between 3.2% and 3.4% by mass inclusive of yttria, or even between 3.2% and 3.3% by mass inclusive of yttria. The powder is binded in the form of granules comprising 5.75% by weight of organic binders.

Then, uniaxial cold pressing of these granules, on an electric press in a cylindrical mold, with a diameter of 36 mm, makes it possible to obtain a pressed pellet. A pressing force of 180 kN is exerted on the mold in order to obtain a good density. Each pellet thus obtained is debinded in air at 900° C. for one hour in order to obtain a brown body.

Each brown body pellet is finally subjected to natural sintering in air, comprising a steady stage of two hours at 1350° C.

After sintering, one of the faces of the ceramic pellet is rectified then polished to a mirror finish (successively, with free grains of diamond with mean diameters of 3 μm then 2 μm).

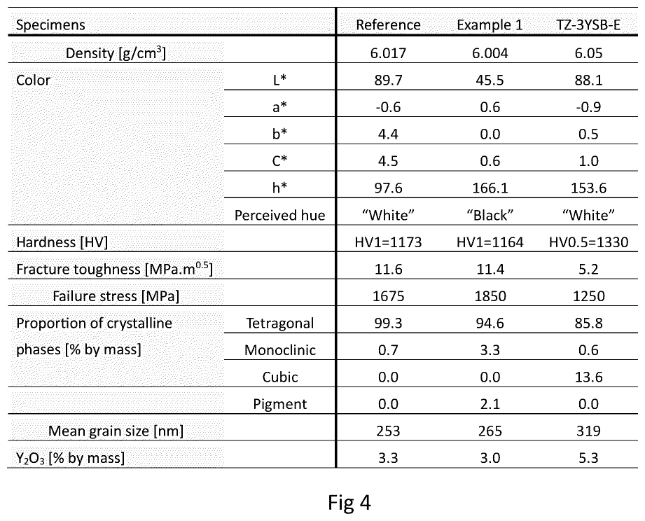

The obtained ceramic pellets based on zirconia are white. A plurality of specimens are thus produced and constitute a “reference”, the chemical composition of which is visible in the table in FIG. 3, and the properties of which are listed in the table in FIG. 4.

It appears that the zirconia constituting the reference specimen is white, opaque, contains 3.3% by mass of yttrium oxide Y₂O₃, has a fracture toughness of 11.6 MPa·m^{0.5} and a failure stress of 1675 MPa. It has a density of 6.017 g/cm³. The mean size of its grains is 253 nm. The alumina doping amounts to 0.57% by mass. The chemical purity is such that the proportion of its main elements listed below represents nearly the totality of its composition (Zr+Y+Al+Hf+Si+Mg+O>99.9% and Fe+Ni+Cr=0). Furthermore, it is found that the yttria is distributed homogeneously in the zirconia. Lastly, it consists of 99.30% by mass of tetragonal phase and 0.70% by mass of monoclinic phase. It is noted that certain molecules are present in the form of non-detectable traces, indicated by the indication “≤LOD” in the table in FIG. 3.

A description will now be given of the manufacture of a technical ceramic according to one exemplary embodiment of the invention. For this, the same ceramic powder is used as for the preceding reference ceramic.

The powder is binded in the form of granules comprising 5.75% by weight of organic binders. Uniaxial cold pressing is implemented in the same way as for the reference ceramic described above.

Each pellet thus obtained is debinded in air at 900° C. for 1 hour in order to obtain a brown body. This brown body is impregnated with a solution containing metal salts which are intended to introduce at least one additional element, then dried (in an oven at 80° C.) for four hours. The composition of this impregnation solution is described in the table in FIG. 2.

In this example, the aqueous solution comprises three metal salts which make it possible for the ceramic to be impregnated with the additional elements Fe, Ni, Cr. In a variant or combination, impregnation with all or some of the elements Zn, Co, Mn, Cu, Ti, Ta, W, Pt would be conceivable.

Each impregnated brown body pellet is finally subjected to natural sintering in air at 1350° C. with a steady stage of two hours. After sintering, a face of the ceramic pellet is rectified then polished.

The ceramic pellets obtained are completely black. They are opaque.

It is apparent that the manufacturing process according to this example of the invention is differentiated from that implemented to manufacture the ceramic reference pellets by the impregnation step Ei.

The pellets obtained form specimens which will be denoted “example 1” in the tables in FIGS. 3 and 4.

The sintered technical ceramic based on zirconia according to example 1 is black and opaque. In addition, it contains a proportion by mass of 3.0% of yttrium oxide Y₂O₃. The proportion by mass of alumina is 0.44%. The sum of the main elements listed below is greater than or equal to 99.9%, that is to say Zr+Y+Al+Hf+Si+Mg+Fe+Ni+Cr+O>99.9% by mass.

In addition, the sintered technical ceramic based on zirconia according to example 1 has a fracture toughness of 11.4 MPa·m^{0.5} and a failure stress of 1850 MPa. It has a density of 6.004 g/cm³. Yttria is distributed homogeneously in the zirconia. It consists of 94.6% by mass of tetragonal phase, 3.3% by mass of monoclinic phase and 2.1% by mass of pigment.

This material according to example 1 may be considered a dense sintered “ceramic-ceramic” technical composite, “ceramic-ceramic” composite denoting a ceramic containing at least two types of ceramics of different compositions, of ceramic nature. It has an at least dual microstructure consisting of:
grains of zirconia, the mean equivalent diameter of which is 265 nm;
grains of pigments, the mean equivalent diameter of which is 260 nm.

In addition, a type of supplementary specimen is manufactured. Specifically, similar characterizations are carried out on a third ceramic based on 3Y zirconia powder, denoted TZ-3YS-BE, which is shaped in a similar manner to the reference specimens. This third technical ceramic is differentiated from the first and second ceramics by a greater quantity of yttrium oxide.

The third ceramic TZ-3YS-BE is a white zirconia containing a proportion by mass of 5.3% of yttrium oxide Y₂O₃.

As is apparent in the table in FIG. 4, the mechanical properties of the ceramic according to example 1 of the invention are significantly improved relative to the reference ceramic. Specifically, its failure stress is greatly increased, at 1850 MPa, and the fracture toughness is kept high and almost unchanged at 11.4 MPa·m^{0.5}. The other example of ceramic TZ-3YS-BE is distinguished principally from the reference ceramic by a significantly greater proportion of yttrium oxide. It appears that its mechanical properties are significantly lower than those of the reference ceramic.

Thus, example 1 forms a particularly advantageous sintered technical ceramic according to the invention. More generally, such a ceramic may be defined in that it comprises the following composition:
a proportion by mass of zirconia ZrO₂ comprised between 92% and 93%;
yttrium oxide Y₂O₃ in a proportion by mass comprised between 2.9% and 3.1% inclusive; and
hafnium oxide HfO₂ in a proportion by mass comprised between 1.65% and 1.75% inclusive; and
alumina Al₂O₃ in a proportion by mass comprised between 0.4% and 0.5% inclusive; and
magnesium oxide MgO in a proportion by mass comprised between 0.25% and 0.35% inclusive; and
an additional element Fe, in the form of iron oxide Fe₂O₃ in a proportion by mass comprised between 0.75% and 0.85%; and
an additional element Ni, in the form of nickel oxide NiO in a proportion by mass comprised between 0.75% and 0.85%; and
an additional element Cr, in the form of chromium oxide in a proportion by mass comprised between 0.5% and 0.65%;
non-detectable traces of other components (see the table in FIG. 3).

A description will now be given of the manufacture of a technical ceramic according to a second exemplary embodiment of the invention, denoted “example 2”.

It is carried out in all respects as per example 1, except concerning the impregnation solution: for example 2, said solution is two-fold diluted with respect to the solution used in example 1. The resultant compositions of the sintered ceramic are indicated in the table in FIG. 3. The ceramic according to this example also has the notable mechanical properties of the invention, a high fracture toughness and failure stress. It is noted that the color of example 2, which is also satisfactory, is different from that of example 1: ΔL*=−0.2; Δa*=−1.0; Δb*=−0.8; ΔC*_{ab}=−1.3; Δh*_{ab}=+2.8; ΔE*_{ab}=1.30.

1. A sintered technical ceramic based on zirconia ZrO₂, wherein the sintered technical ceramic comprises:
yttrium oxide Y₂O₃ in a proportion by mass comprised within a range of from 2.5% to 3.6%;
at least one complementary component selected from the group consisting of hafnium oxide HfO₂, alumina Al₂O₃ in a proportion by mass comprised within a range of from 0.1% to 0.5%, and magnesium oxide MgO;
at least one additional element selected from the group consisting of Fe, Ni, Cr, Zn, Co, Mn, Cu, Ti, Ta, W, and Pt, the proportion by mass of the at least one additional element being at least 0.1%.

2. The sintered technical ceramic as claimed in claim 1, wherein sintered technical ceramic comprises yttrium oxide Y₂O₃ in a proportion by mass of at most 3.5%.

3. The sintered technical ceramic as claimed in claim 1, wherein the sintered technical ceramic comprises a proportion by mass of zirconia ZrO₂ of at least 80%.

4. The sintered technical ceramic as claimed in claim 1, wherein the sintered technical ceramic comprises:
hafnium oxide HfO₂ in a proportion by mass comprised within a range having a lower limit strictly greater than 0% and an upper limit equal to 1.9%; and/or
alumina Al₂O₃ in a proportion by mass comprised within a range of from 0.1% 0.5%; and/or
magnesium oxide MgO in a proportion by mass comprised in range a of from 0% to 0.4%.

5. The sintered technical ceramic as claimed in claim 1,
wherein the at least one additional element is selected from the consisting of Fe, Cr, Ni, Co, Cu, Mn, Zn, Ti, Ta, W, and/or
wherein the at least one additional element is present in the sintered technical ceramic in an oxidized form of at least one additional element, and/or in a form of a carbide, a nitride and/or a boride.

6. The sintered technical ceramic as claimed in claim 1, wherein the sintered technical ceramic comprises:
a proportion by mass of zirconia ZrO₂ comprised within a range of from 92% to 93%;
yttrium oxide Y₂O₃ in a proportion by mass comprised within a range of from 2.9% to 3.1%; and
hafnium oxide HfO₂ in a proportion by mass comprised within a range of from 1.65% to 1.75%; and
alumina Al₂O₃ in a proportion by mass comprised within a range of from 0.4% to 0.5%; and
magnesium oxide MgO in a proportion by mass comprised within a range of from 0.25% to 0.35%; and
an additional element Fe, in a form of iron oxide Fe₂O₃ in a proportion by mass comprised within a range of from 0.75% to 0.85%; and
an additional element Ni, in a form of nickel oxide NiO in a proportion by mass comprised within a range of from 0.75% to 0.85%; and
an additional element Cr, in a form of chromium oxide in a proportion by mass comprised in a range of from 0.5% to 65%.

7. The sintered technical ceramic as claimed in claim 1, wherein a total proportion by mass of all elements selected from the group consisting of Zr, Hf, Y, Al, Si, Mg, Fe, Ni, Cr, Zn, Co, Mn, Cu, Ti, Ta, W, Pt and O in the technical ceramic is at least 99.9%.

8. The sintered technical ceramic as claimed in claim 1, wherein the sintered technical ceramic comprises grains of zirconia, a mean equivalent diameter of which is at least 200 nm.

9. The sintered technical ceramic as claimed in claim 1, wherein the sintered technical ceramic comprises grains of zirconia and/or grains of oxides, of carbides, of nitrides, and/or of spinels of the at least one additional element, a mean equivalent diameter of which is at most 2 μm.

10. The sintered technical ceramic as claimed in claim 1, wherein the sintered technical ceramic comprises grains of oxides, of carbides, of nitrides, and/or of spinels of the at least one additional element, a mean equivalent diameter of which is at least 200 nm.

11. A body based on the sintered technical ceramic as claimed in claim 1, wherein the body has a fracture toughness of at least 10 MPa·m^{0.5} and a failure stress of at least 1400 MPa.

12. The body as claimed in claim 11, wherein the body has a density of at least 6.0 g/cm³.

13. A timepiece component a comprising the sintered technical ceramic as claimed in claim 1.

14. The timepiece component as claimed in claim 13, wherein the timepiece component is selected from the group consisting of a timepiece staff, a pawl, a pinion, a wheel, a stone, a bezel insert, a bezel, a winding crown, a watch case, a watch case back, a watch band link, a watch band clasp, a watch band clasp cover, and a watch band clasp cover element.

15. A timepiece comprising the sintered technical ceramic as claimed in claim 1.

16. A process for manufacturing a sintered technical ceramic based on zirconia ZrO₂, wherein the process comprises:
providing a zirconia powder comprising yttrium oxide Y₂O₃ in a proportion by mass comprised within a range of from 2.5% to 3.70% and at least one complementary component selected from the group consisting of hafnium oxide HfO₂, alumina Al₂O₃ in a proportion by mass comprised within a range of from 0.1% to 0.5%, and magnesium oxide MgO, and an organic binder, then
shaping the zirconia powder and then at least partially debinding the zirconia powder to obtain a brown or green body;
impregnating the brown or green body so as to add thereto at least one additional element selected from the group consisting of Fe, Ni, Cr, Zn, Co, Mn, Cu, Ti, Ta, W and Pt, a proportion by mass of the at least one additional element being at least 0.1%; then
sintering the impregnated brown or still-green body in air or under a controlled atmosphere.

17. The process as claimed in claim 16, wherein the process comprises manufacturing the zirconia powder comprising yttrium oxide Y₂O₃ by emulsion detonation synthesis.

18. The process as claimed in claim 16, wherein the proportion by mass of the zirconia powder is comprised within a range of from 2.6% to 3.7%.

19. The sintered technical ceramic as claimed in claim 1, wherein the proportion by mass of the at least one additional element is at least 1.5%.

20. The sintered technical ceramic as claimed in claim 2, wherein the proportion by mass of the yttrium oxide Y₂O₃ is at most 3.1%.
